(19) United States
(12) Patent Application Publication
(10) Pub. No.: US 2011/0209599 A1
(43) Pub. Date: Sep. 1, 2011

(54) M-PALM SYSTEMS

(76) Inventor: Jerry Aponte, North Las Vegas, NV (US)

(21) Appl. No.: 13/028,222

(22) Filed: Feb. 16, 2011

Related U.S. Application Data
(60) Provisional application No. 61/308,652, filed on Feb. 26, 2010.

(51) Int. Cl. G10H 3/00

(52) U.S. Cl. 84/723

(57) ABSTRACT

An electronically-enabled glove system for producing simulated music comprising: a form-fitting hand-glove; integrated electronic tactile sensors able to convert a sensed-pressure into an electronic signal. The integrated electronic tactile sensors are integral within the form-fitting hand-glove and the integrated electronic tactile sensor, when contacting a surface measures the sensed-pressure and converts the sensed-pressure into the electronic signal that is relayed to produce simulated music.

### CROSS-REFERENCE TO RELATED APPLICATION

The present application is related to and claims priority from prior provisional application Ser. No. 61/308,652, filed Feb. 26, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of gloves and more specifically relates to an electronically-enabled glove system for producing simulated music.

### 2. DESCRIPTION OF THE RELATED ART

Music is a very popular form of entertainment in modern societies. A significant number of individuals would like to learn to play an instrument but cannot afford to purchase one or pay for lessons. Video games, another form of entertainment offer individuals a new outlet for playing electronically simulated music but gaming systems can also be very expensive and are not typically able to be played remote from a power source.

Gloves are a garment used for covering the hand(s) of a wearer. Gloves typically have separate sheaths/openings for each finger and the thumb. Gloves may protect and comfort hands against damage by friction, cold or heat, abrasion or chemicals, and disease; or provide a guard for what a bare hand should not touch. Gloves may also be worn for fashion and for activities such as sports or driving. Gloves are typically used as an isolation or gripping means.

Various attempts have been made to solve the above-mentioned problems such as those found in U.S. Pat. Nos. 5,029,508, 4,635,516; 5,119,709; 4,920,848; and 2001/0040550. This prior art is representative of gloves. None of the above inventions and patents, taken either singly or in combination, is seen to describe the invention as claimed.

Ideally, an electronically-enabled glove system should be user-friendly, comfortable in use and, yet would operate reliably and be manufactured at a modest expense. Thus, a need exists for a reliable electronically-enabled glove system able to produce simulated music and to avoid the above-mentioned problems.

### BRIEF SUMMARY OF THE INVENTION

In view of the foregoing disadvantages inherent in the known glove art, the present invention provides a novel electronically-enabled glove system. The general purpose of the present invention, which will be described subsequently in greater detail is to provide and produce simulated music.

An electronically-enabled glove system is disclosed herein for producing simulated music comprising: at least one form-fitting hand-glove; at least one integrated electronic tactile sensor able to convert a sensed-pressure into an electronic signal; and the circuitry necessary to relay the electronic signal. The integrated electronic tactile sensor is integral within the form-fitting hand-glove (in various possible locations). The integrated electronic tactile sensor, when contacting (tapping or otherwise touch/non-touch contacting) a surface measures the sensed-pressure and converts the sensed-pressure into a corresponding electronic signal that is relayed to produce simulated music.

The electronically-enabled glove system for producing simulated music preferably further comprises at least one integral microchip (miniaturized electronic circuit (consisting mainly of a semiconductor device, and passive components) having preprogrammed instrumental sounds stored therein. Additionally speakers may be integrated into the form-fitting hand-glove or be externally in communication such that they are able to play audible music corresponding to the sensed-pressure touch-contact manipulation.

A kit is also disclosed herein for the electronically-enabled glove system comprising the form-fitting hand-glove(s) having integrated electronic tactile sensors; integral speaker(s); at least one DC rechargeable battery; an electroacoustic transducer; and an integral microchip having stored preprogrammed instrumental sounds.

Additionally a method is described for using the electronically-enabled glove system comprising at least the steps of: donning the form-fitting glove; activating the electronically-enabled glove system; and contacting a surface to create an audible musical sound between about 20 Hz and 20,000 Hz.

The present invention holds significant improvements and serves as an electronically-enabled glove system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, electronically-enabled glove system, constructed and operative according to the teachings of the present invention.

FIG. 1 shows a perspective view illustrating an electronically-enabled glove system in use according to an embodiment of the present invention.

FIG. 2 is a rear perspective view illustrating a form-fitting hand-glove of the electronically-enabled glove system according to an embodiment of the present invention of FIG. 1.

FIG. 3 is another perspective view illustrating the form-fitting hand-glove according to an embodiment of the present invention of FIG. 1.

FIG. 4 is a side perspective view illustrating the form-fitting hand-glove according to an embodiment of the present invention of FIG. 1.

FIG. 5 is a flowchart illustrating a method of use for the electronically-enabled glove system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to an electronic glove device and more particularly to an electronically-enabled glove system as used to improve and produce simulated music. Referring now generally to the electronically-enabled glove system, M-PALM comprises a pair of gloves with integrated electronic pressure sensors for making simulated musical sounds. This item may be comprised of form-fitting gloves made of virtually any combination of natural and synthetic fibers. The pressure sensors and associated electronics can be incorporated into the design that allows a musical sound to be produced when the sensors are tapped or pressed against a surface. The pressure sensors can be programmed to differentiate between a hard and a soft press to produce a hard or soft sound, accordingly. Pressure sensors can be located in the fingertips, on the backs of the knuckles, on the sides of the hands or on other locations on the hands and wrists.

A microchip containing preprogrammed instrumental sounds can be included in the top portion of the gloves. It may also be possible for different instrumental sounds to be uploaded into the microchip via a USB port or by other equivalent means. Small speakers may be sewn into the backs of the gloves and/or the gloves may transmit the musical sounds to an external speaker arrangement. The device may be powered by a rechargeable battery or by other suitable equivalent means. This product may be available to consumers in several sizes to substantially ensure an appropriately snug fit.

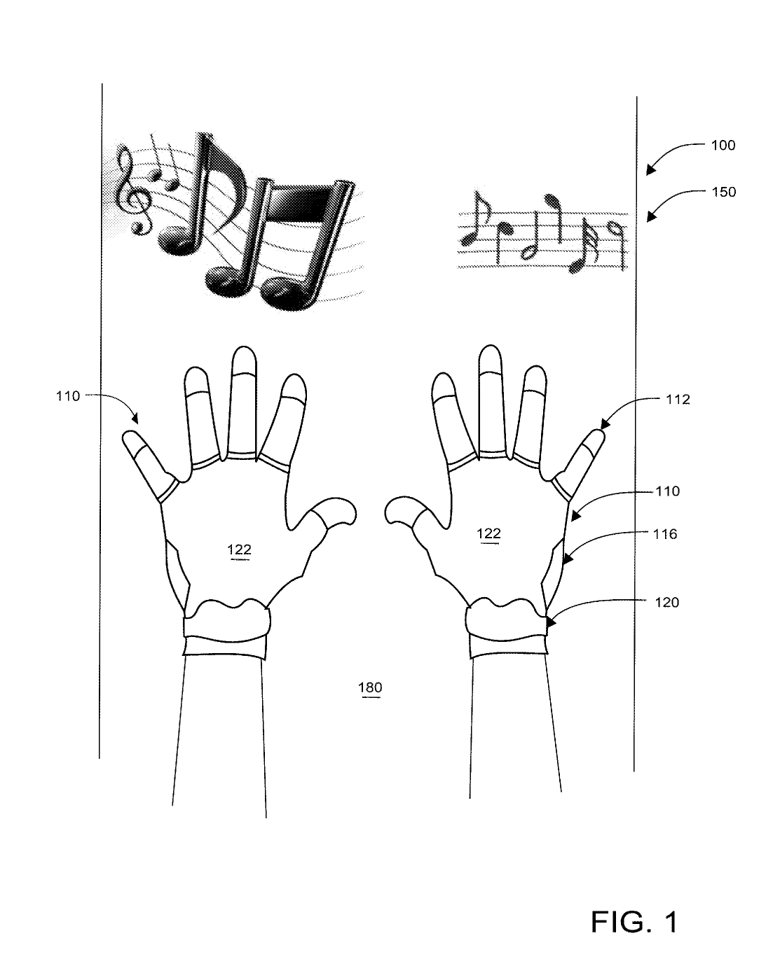

Referring now more specifically to the drawings by numerals of reference there is shown in FIG. 1, a perspective view illustrating electronically-enabled glove system 100 in use (in-use condition 150) according to an embodiment of the present invention.

Electronically-enabled glove system 100 for producing simulated music within the present embodiment preferably comprises: at least one form-fitting hand-glove 110; at least one integrated electronic tactile sensor 130 able to convert a sensed-pressure into an electronic signal. Integrated electronic tactile sensor 130 is preferably integral within form-fitting hand-glove 110. Integrated electronic tactile sensor 130, when contacting a surface (plane 180, as shown) measures sensed-pressure and converts sensed-pressure into electronic signal that is relayed to produce simulated music. Relaying occurs via suitable communication means to transmit electronic signals. Those with ordinary skill in the art will now appreciate that upon reading this specification and by their understanding the art of electronic signals as described herein, methods of transmission and communication means for will be understood by those knowledgeable in such art. For example transmission means may comprise various wired or wireless means or combinations thereof.

Electronically-enabled glove system 100 further preferably comprises at least one integral microchip 160 having stored preprogrammed instrumental sounds. Integral microchip 160 is desirable to provide a lightweight controlling means. Additionally, integral microchip 160 is preferably durable and/or suitably protected from impact damage, moisture and other potentially compromising conditions.

Preprogrammed instrumental sounds as stored in integral microchip 160 may comprise various tones, tunes, notes, songs, messages, noises or the like. Examples may include notes as played by various musical instruments such as drums or other percussion instruments, pianos/keyboard, horns and various wind instruments, stringed instruments, voice, electronic instruments and the like whose medium is sound. Electronic tactile sensor 130 may comprises a transducer 140. Transducer 140 is able to finely differentiate between a ‘hard’ and a ‘soft’ press to produce a corresponding ‘hard’ or ‘soft’ sound. Transducer 140 is used to convert one type of energy, here mechanical touch-contact, to another, in this case electrical signal(s). In this way the present invention may convert mechanical touches into electrical signals that are useful for producing music, such that an individual is able to creatively compose music with a minimum of instrument-playing know-how.

As previously mentioned, integrated electronic tactile sensor(s) 130 may be located in at least one fingertip portion 112, and/or in at least one knuckle portion 114 of form-fitting hand-glove 110. Additionally, integrated electronic tactile sensor(s) 130 may be located in at least one side portion 116, and/or in at least one palm portion 118 of form-fitting hand-glove 110. Integrated electronic tactile sensor(s) 130 may also be located in at least one wrist portion 120. Alternate embodiments may have integrated electronic tactile sensor(s) 130 in other portions of form-fitting hand-glove 110.

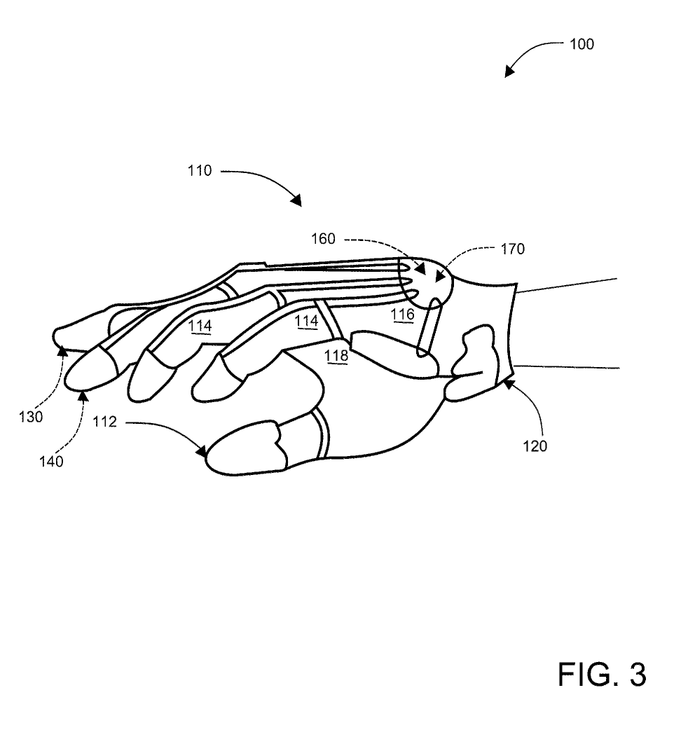

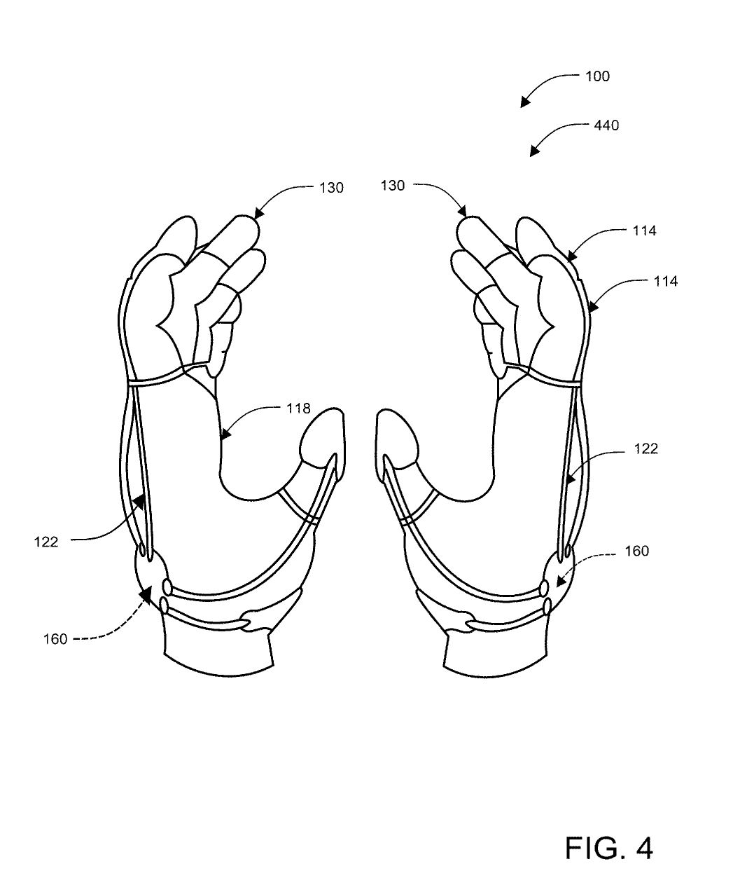

In certain embodiments, during in-use condition 150, electronic signal is deliverable to a remote external speaker arrangement and in other embodiments at least one integral speaker 170 is affixed to a back portion 122 of form-fitting hand-glove 110, as shown in FIGS. 3 and 4. In this way form-fitting hand-glove 110 is able to produce music without a hard-wired attachment—in a remote manner.

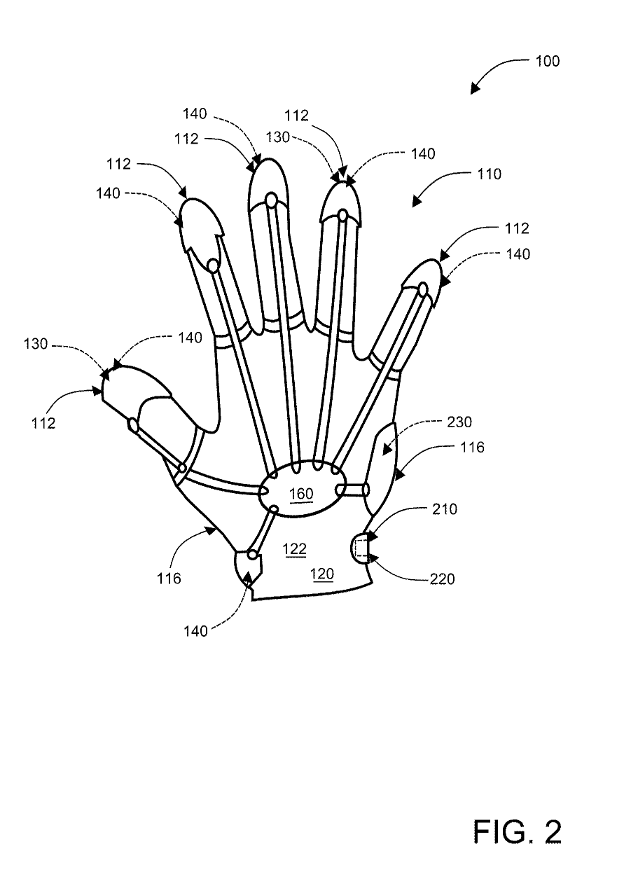

Referring now to FIGS. 2 and 3, showing various perspective views illustrating form-fitting hand-glove 110 of electronically-enabled glove system 100 according to an embodiment of the present invention of FIG. 1.

Electronically-enabled glove system 100 for producing simulated music preferably further comprises a communication connection 210, such as a USB port 220 for uploading preprogrammed instrumental sounds to integral microchip 160. In this way the present invention may be uploaded or otherwise put in direct or indirect communication with a computing means. Electronically-enabled glove system 100 further comprises powerer 230. Powerer 230 preferably comprises at least one battery (rechargeable/non-chargeable or other). In this way powerer 230 may comprise a DC power source such as a dry cell battery.

Referring now to FIG. 4, showing a side perspective view illustrating form-fitting hand-glove 110 according to an embodiment of the present invention of FIG. 1.

As described previously, form-fitting hand-glove 110 comprises integrated electronic tactile sensor 130. The user-wearer dons form-fitting hand-glove(s) 110 and by depressing fingertip portion 112 (via fingers) against a surface (even against each other) activates integrated electronic tactile sensor 130 causing an electrical signal to be sent to microchip 160 to be processed followed by an output from microchip 160 to induce activation of integral speaker 170 to provide an audible output. The instant invention may be useful as a means for experimenting with music and can be used by novices for ‘playing’ or by experienced artists to create musical compositions. In this way the present invention is useful for a host of user-wearers of differing abilities. Form-fitting hand-glove(s) 110 may be sold in various sizes and be made from different materials. In certain embodiments form-fitting hand-glove(s) 110 may comprise indicia, and/or decoration means.

Electronically-enabled glove system 100 may be sold as kit 440 comprising the following parts: at least one form-fitting hand-glove 110 having integrated electronic tactile sensors 130; an electroacoustic transducer, (speaker—integral or external to)—(embodied as integral speaker(s) 170 in the embodiment shown); at least one DC rechargeable battery (powerer 230); an integral microchip 160 having preprogrammed instrumental sounds; and at least one set of user instructions. Electronically-enabled glove system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

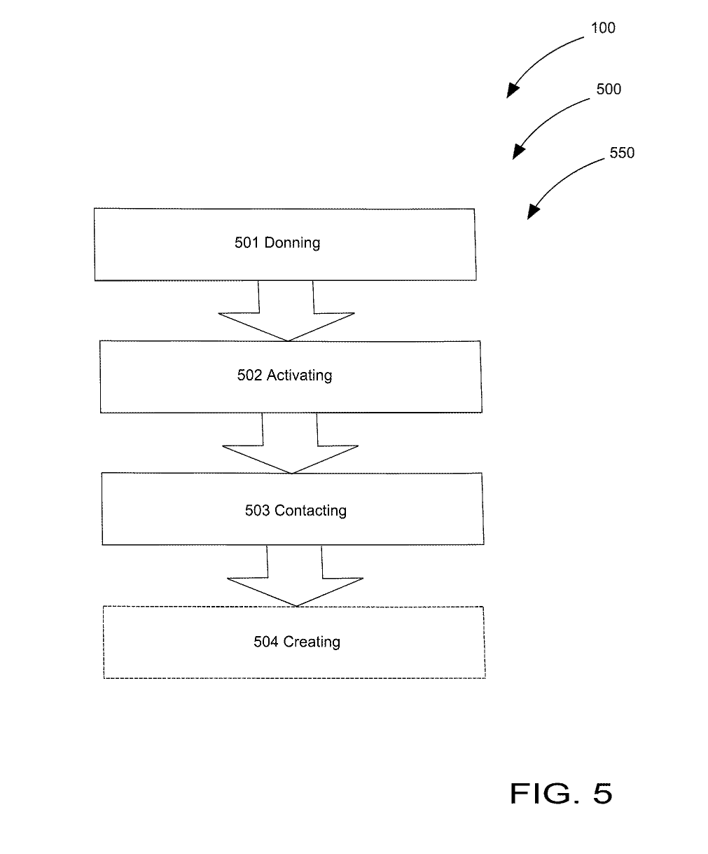

Referring now to FIG. 5, showing flowchart 550 illustrating a method of use 500 for electronically-enabled glove system 100 according to an embodiment of the present invention of FIGS. 1-4.

A method for using (method of use 500) an electronically-enabled glove system 100 at least preferably comprising the steps of: step one 501 donning form-fitting glove(s) 110; step two 502 activating electronically-enabled glove system 100; and step three 503 contacting a surface (tapping or otherwise pressing against a surface) to create an audible musical sound between about 20 Hz and 20,000 Hz. Optionally, the user-wearer may create a series of audible musical sounds to create a composition in step four 504. Next the user may opt to deactivate electronically-enabled glove system 100 for storage and non-use periods.

It should be noted that step 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electronically-enabled glove system for producing simulated music comprising:
a form-fitting hand-glove;
at least one integrated electronic tactile sensor able to convert a sensed-pressure into an electronic signal; and
wherein said integrated electronic tactile sensor is integral within said form-fitting hand-glove and said integrated electronic tactile sensor, when contacting a surface measures said sensed-pressure and converts said sensed-pressure into said electronic signal that is relayed to produce said simulated music.

2. The electronically-enabled glove system for producing simulated music of claim 1 further comprising at least one integral microchip having preprogrammed instrumental sounds.

3. The electronically-enabled glove system for producing simulated music of claim 2 further comprising a communication connection.

4. The electronically-enabled glove system for producing simulated music of claim 3 wherein said communication connection comprises a USB port for uploading said preprogrammed instrumental sounds to said integral microchip.

5. The electronically-enabled glove system for producing simulated music of claim 1 further comprising at least one integral speaker.

6. The electronically-enabled glove system for producing simulated music of claim 1 further comprising a powerer.

7. The electronically-enabled glove system for producing simulated music of claim 6 wherein said powerer comprises a DC source.

8. The electronically-enabled glove system for producing simulated music of claim 7 wherein said DC source is rechargeable.

9. The electronically-enabled glove system for producing simulated music of claim 1 wherein said integrated electronic tactile sensor comprises a transducer.

10. The electronically-enabled glove system for producing simulated music of claim 1 wherein said transducer is able to finely differentiate between a hard and a soft press to produce a hard or soft sound.

11. The electronically-enabled glove system for producing simulated music of claim 1 wherein said integrated electronic tactile sensor(s) are located in at least one fingertip portion of said form-fitting hand-glove.

12. The electronically-enabled glove system for producing simulated music of claim 1 wherein said integrated electronic tactile sensor(s) are located in at least one knuckle portion of said form-fitting hand-glove.

13. The electronically-enabled glove system for producing simulated music of claim 1 wherein said integrated electronic tactile sensor(s) are located in at least one side portion of said form-fitting hand-glove.

14. The electronically-enabled glove system for producing simulated music of claim 1 wherein said integrated electronic tactile sensor(s) are located in at least one palm portion of said form-fitting hand-glove.

15. The electronically-enabled glove system for producing simulated music of claim 1 wherein said integrated electronic tactile sensor(s) are located in at least one wrist portion of said form-fitting hand-glove.

16. The electronically-enabled glove system for producing simulated music of claim 1 wherein said electronic signal is deliverable to a remote external speaker arrangement.

17. The electronically-enabled glove system for producing simulated music of claim 5 wherein said at least one integral speaker is affixed to a back of said form-fitting hand-glove.

18. The electronically-enabled glove system for producing simulated music of claim 1 wherein said form-fitting hand-glove is able to produce music without a hard-wired attachment.

19. A kit for an electronically-enabled glove system comprising a form-fitting hand-glove having integrated electronic tactile sensors; integral speaker(s); at least one DC rechargeable battery; an electroacoustic transducer; and an integral microchip having preprogrammed instrumental sounds.

20. A method for using an electronically-enabled glove system comprising the steps of:
donning a form-fitting glove;
activating said electronically-enabled glove system; and
contacting a surface to create an audible musical sound between about 20 Hz and 20,000 Hz.
